(19) United States
(12) Patent Application Publication
(10) Pub. No.: US 2018/0010214 A1
(43) Pub. Date: Jan. 11, 2018

(54) HIGH STRENGTH HIGH CREEP-RESISTANT CAST ALUMINUM ALLOYS AND HPDC ENGINE BLOCKS

(71) Applicant: GM GLOBAL TECHNOLOGY OPERATIONS LLC, Detroit, MI (US)

(72) Inventors: Qigui Wang, Rochester Hills, MI (US); Melani R. Wright, Clarkston, MI (US); William L. Miller, Birmingham, MI (US); Jianghuai Yang, Rochester Hills, MI (US)

(21) Appl. No.: 15/202,136

(22) Filed: Jul. 5, 2016

(51) Int. Cl. C22C 21/02; F02F 7/00

(52) U.S. Cl. CPC C22C 21/02; F02F 7/0085; F02F 2200/06; F02F 2007/009

(57) ABSTRACT

Aluminum alloys having improved properties are provided. The alloy includes about 8 to about 12 weight percent silicon, about 0.5 to about 1.5 weight percent copper, about 0.2 to about 0.4 weight percent magnesium, 0 to about 0.5 weight percent iron, about 0.3 to about 0.6 weight percent manganese, 0 to about 1.5 weight percent nickel, and 0 to about 0.5 weight percent zinc. Aluminum may be present in an amount between about 80 and 91 weight percent. The alloy may include about 0.1 to about 0.5 weight percent each of trace elements such as titanium, vanadium, and/or zirconium, and up to about 0.25 weight percent of all other trace elements. In addition, the alloy may contain about 0.03 to about 0.1 weight percent of strontium, sodium, and/or antimony, and up to 5 ppm phosphorus. Also disclosed is a high pressure die cast article, such as an engine block.

### FIELD

The present disclosure relates generally to aluminum alloys, and more particularly, to high strength cast aluminum alloys that have improved casting quality and mechanical properties, as well as cast articles made therefrom, such as engine blocks made from high pressure die casting.

### INTRODUCTION

Typical high pressure die casting (HPDC) aluminum alloys are Al—Si based alloys that contain about 3˜4% Cu. It is generally accepted that copper (Cu) has the single greatest impact of all alloying elements on the strength and hardness of aluminum casting alloys, both heat-treated and not heat-treated and at both ambient and elevated service temperatures. Copper also improves the machinability of alloys by increasing matrix hardness, making it easier to generate small cutting chips and fine machined finishes.

A process known as high pressure die casting (HPDC) is widely used for mass production of metal components because of low cost, close dimensional tolerances (near-net-shape) and smooth surface finishes. Manufacturers in the motor vehicle industry are now increasingly required to produce near-net-shape aluminum components with a combination of high tensile properties and ductility, and high pressure die casting process is the most economic production method for high quantities.

One disadvantage of the conventional HPDC process, however, is that the parts are not amenable to solution treatment (T4) at a high temperatures, such as 500° C., which significantly reduces the potential of precipitation hardening through a full T6 and/or T7 heat treatment. This is because of the presence of a high quantity of porosity and voids in the finished HPDC components due to shrinkage during solidification, and in particular, the entrapped gases during mold filling, such as air, hydrogen or vapors formed from the decomposition of die wall lubricants. It is almost impossible to find a conventional HPDC component without large gas bubbles. The internal pores containing gases or gas forming compounds in the high pressure die castings expand during conventional solution treatment at elevated temperatures, resulting in the formation of surface blisters on the castings. The presence of these blisters affects not only the appearance of the castings, but also dimensional stability, and in particular, mechanical properties of the HPDC components.

Because of the potential blister problem, conventional HPDC aluminum components are mostly used in as-cast and/or, to a lesser extent, in aged conditions such as T5, but not with T6 or T7 treatments. Even with the T5 aging, the increase of yield strength is very limited and sometimes there is no improvement because the concentrations of hardening solutes for artificial aging (T5) in the current as-cast HPDC parts are very low. As a result, the mechanical properties of the HPDC aluminum parts are usually low for a given aluminum alloy in comparison with other casting processes, because the aluminum parts made by other casting processes can be heat treated in full T6 or T7 conditions.

Considering that the conventional HPDC aluminum components inevitably contain internal porosity, artificial aging (T5) becomes a very important step to attempt to achieve some of the desired tensile properties without causing blistering problems. The strengthening resulting from aging occurs because the solute taken into supersaturated solid solution forms precipitates which are finely dispersed throughout the grains and which increase the ability of the alloy to resist deformation by the process of slip and plastic flow. Maximum hardening or strengthening occurs when the aging treatment leads to the formation of a critical dispersion of at least one type of these fine precipitates.

Furthermore, high temperature and high sealing pressure is seen in Siamese areas, or conjoined cylinder bore edge areas, of cast aluminum engine blocks, particularly with high-demand engines. As a result, it is common to observe aluminum recession in the Siamese areas, excess plastic deformation, and/or creep during engine combustion.

Accordingly, there is a need to develop heat-resistant high strength cast aluminum alloys for use in high pressure die cast articles, such as engine blocks.

### SUMMARY

This disclosure provides high strength cast aluminum alloys that have improved casting quality and mechanical properties, as well as cast articles made therefrom, such as engine blocks made from high pressure die casting.

The alloy may contain at least one of the castability and strength-enhancement elements, such as silicon, copper, magnesium, manganese, iron, zinc, and/or nickel. The microstructure of the alloy may contain at least one insoluble solidified and/or precipitated particles with at least one alloying element.

In one example, which may be combined with or separate from the other examples and features provided herein, an aluminum alloy suitable for high pressure die casting is provided. The aluminum alloy may contain: about 8 to about 12 weight percent silicon; about 0.5 to about 1.5 weight percent copper; about 0.2 to about 0.4 weight percent magnesium; 0 to about 0.5 weight percent iron; about 0.3 to about 0.6 weight percent manganese; 0 to about 1.5 weight percent nickel; and 0 to about 0.5 weight percent zinc.

Additional features may be provided, including but not limited to the following: the aluminum alloy further comprising about 80 to about 91 weight percent aluminum; the aluminum alloy further comprising about 0.1 to about 0.5 weight percent each of titanium, vanadium, and zirconium.

In another example, which may be combined with or separate from the other examples and features provided herein, the aluminum alloy contains: about 10 to about 12 weight percent silicon; about 0.75 to about 1.5 weight percent copper; about 0.35 to about 0.4 weight percent magnesium; 0 to about 0.4 weight percent iron; about 0.4 to about 0.5 weight percent manganese; 0 to about 0.5 weight percent nickel; and 0 to about 0.2 weight percent zinc.

Further additional features may be provided, such as: the aluminum alloy further comprising about 0.15 to about 0.2 weight percent each of titanium, vanadium, and/or zirconium; the aluminum alloy further comprising 0 to about 0.25 weight percent of other trace elements (apart from titanium, vanadium, and zirconium); the aluminum alloy further comprising about 0.03 to about 0.1 weight percent of a morphology improver such as strontium, sodium, antimony, and/or combinations thereof; the aluminum alloy further comprising about 0 to about 5 ppm phosphorus, or in some cases, less than about 3 ppm phosphorus; the iron and manganese content being provided each in an amount so that a sludge factor is less than or equal to 1.4, wherein the sludge factor is calculated by the following equation: Sludge factor=(1×wt % iron)+(2×wt % manganese)+(3×wt % chromium), and wherein the aluminum alloy contains essentially 0 chromium; the aluminum alloy containing essentially 0 Beta Iron Phase (β-Fe Phase); the aluminum alloy comprising about 0.2 to about 0.5 weight percent iron; the manganese and the iron each being provided in an amount above a soldering prevention line, the soldering prevention line being defined as a line above which soldering of the aluminum alloy is not substantially possible, or the line below which die soldering of the aluminum alloy occurs; the aluminum alloy being lighter than an A380 aluminum alloy; the aluminum alloy having a density of about 2.7 g/cm³; wherein the aluminum alloy as-cast and prior to any age-hardening has a yield strength greater than or equal to 160 MPa, an ultimate tensile strength greater than or equal to 281 MPa, and a strain of at least 2.8%; wherein the aluminum alloy, after undergoing a T5 age-hardening treatment, has a yield strength greater than or equal to 235 MPa, an ultimate tensile strength greater than or equal to 332 MPa, and a strain of at least 1.9%.

In yet another example, which may be combined with or separate from the other examples and features described herein, the aluminum allow may consist essentially of: about 10.5 weight percent silicon, about 0.4 weight percent iron, about 1.5 weight percent copper; about 0.5 weight percent manganese; about 0.35 weight percent magnesium; about 0.4 weight percent zinc; and the balance aluminum.

In still another example, which may be combined with or separate from the other examples and features described herein, the aluminum alloy may consist essentially of: about 8.5 weight percent silicon; about 0.5 weight percent manganese; about 0.5 weight percent zinc; about 0.3 weight percent zirconium; about 0.3 weight percent titanium; about 0.3 weight percent vanadium; about 0.4 weight percent magnesium; about 0.4 weight percent iron; about 0.04 weight percent of a silicon particle morphology improver such as strontium, sodium, and antimony; 0 to about 0.01 weight percent trace elements; and the balance aluminum.

In still another example, which may be combined with or separate from the other examples and features described herein, the aluminum alloy may consist essentially of: about 12 weight percent silicon; about 0.5 weight percent manganese; about 0.2 weight percent zinc; about 0.25 weight percent zirconium; about 0.25 weight percent titanium; about 0.25 weight percent vanadium; about 0.35 weight percent magnesium; about 0.4 weight percent iron; about 0.04 weight percent of a morphology improver such as strontium, sodium, and antimony; 0 to about 0.01 weight percent trace elements; and the balance aluminum.

A high pressure die cast article, such as an engine block, is provided and cast from any of the versions of the aluminum alloy disclosed herein.

### BRIEF DESCRIPTION OF THE DRAWINGS

The drawings are provided for illustration purposes only and are not intended to limit this disclosure or the claims appended hereto.

FIG. 1 is a graph showing a calculated phase diagram of A380 HPDC alloy showing phase transformations as a function of copper (Cu) content;

FIG. 2 is a graph showing a calculated phase diagram of a cast aluminum alloy showing phase transformations as a function of Mg content;

FIG. 3 is a graph of calculated phase fractions showing no formation of Mg₂Si with the proposed composition;

FIG. 4 is a graph showing a calculated solid fraction during solidification showing the effect of Zn on the alloy solidus;

FIG. 5 is a graph showing calculated solid fractions showing formation of beta-Al₅FeSi phase (˜2.5%) in traditional A380 alloy; and

FIG. 6 is a graph showing an Fe—Mn interaction by which an optimized amount of Fe and Mn may be selected for including in the alloy of the present disclosure.

### DETAILED DESCRIPTION

High strength and high creep-resistant cast aluminum alloys are provided. In comparison to other aluminum alloys, these alloys exhibit improved material strength and creep resistance at elevated temperatures. These alloys may also exhibit improved castability and reduced porosity, as well as reduced hot cracking during tooling extraction. As a result, the scrap rate for aluminum casting and the manufacturing cost can be reduced. In some examples, alloy high temperature properties and engine performance can be improved. For example, inter-bore cooling can be reduced, eliminated, or avoided. Further, in some examples, the alloy density can be reduced. In some examples, the alloys may successfully undergo T6 or T7 treatments.

The alloy may contain at least one of the castability and strength enhancement elements such as silicon, copper, magnesium, manganese, iron, zinc, and nickel. The microstructure of the alloy contains one or more insoluble solidified and/or precipitated particles with at least one alloying element.

The aluminum alloy may include by weight about 8 to about 12 weight percent (wt %) silicon (Si), about 0.5 to about 1.5 wt % copper (Cu) (in some versions, about 0.6 to about 1.5 wt % Cu), about 0.3 to about 0.4 wt % magnesium (Mg) (in some cases, magnesium may be provided in a quantity as low as about 0.2 wt %), 0.5 wt % max iron (Fe) (or 0 to about 0.5 wt % iron), about 0.3 to about 0.6 wt % manganese (Mn), about 1.5 wt % max nickel (Ni) (or 0 to about 1.5 wt % nickel), about 0.5 wt % max zinc (Zn) (or 0 to about 0.5 wt % zinc), about 0.25 wt % max (or 0 to about 0.25 wt %) each of trace elements such as titanium (Ti), zirconium (Zr), and vanadium (V). In some versions, the Ti, Zr, and V may each be provided in an amount of about 0.1 to about 0.5 weight percent.

Preferably, the alloy composition may contain about 10 to about 12 wt % silicon, about 0.75 to about 1.5 wt % copper, about 0.35 to about 0.4 wt % magnesium, about 0.4 wt % max iron (or 0 to about 0.4 wt % iron), about 0.4 to about 0.5 wt % manganese, about 0.5 wt % max nickel (or 0 to about 0.5 wt % nickel), about 0.2 wt % max zinc (or 0 to about 0.2 wt % zinc), about 0.2 wt % max (or 0 to about 0.2 wt %) each of trace elements such as titanium, zirconium, and vanadium, about 0.25% max (or 0 to about 0.25 wt %) total other trace elements, and the balance aluminum (Al). In some versions, each of the Ti, Zr, and V are provided in an amount of about 0.15 to about 0.2 wt % each. To further reduce die soldering and improve Si morphology, the alloy may contain small amount of strontium (Sr), sodium (Na), or antimony (Sb) (<0.1 wt %, or 0 to about 0.1 wt %). In some versions, the Sr, Na, or Sb are provided in an amount of about 0.03 to about 0.1 wt %. The silicon particle size and morphology may be also refined by controlling phosphorus (P) content in the alloy (<5 ppm, preferably <3 ppm; or 0 to about 5 ppm).

Two examples of composition ranges of the new alloy (called Version 1 and Version 2 in these examples) are listed in Table 1, compared with the other commercially available HPDC alloys.

TABLE 1
Chemical compositions of two versions of the new alloy and commercial alloys 380, 383 and 360 alloys.

| | | | | | | | | Sr/Na/ | | | | | |
|---|---|---|---|---|---|---|---|---|---|---|---|---|---|
| Alloy | Si | Cu | Mg | Fe | Mn | Ni | Zn | Sb | Ti | Zr | V | P | Others |
| A380 | 7.5-9.5 | 3.0-4.0 | 0.1 | 0.7-1.5 | <0.5 | <0.5 | 1.5-3 | | | | | | <0.5 in |
| | | | | | | | | | | | | | total |
| 383 | 9.5-11.5 | 2.0-3.0 | 0.1 | 0.7-1.3 | <0.5 | <0.3 | 1.5-3 | | | | | | <0.5 in |
| | | | | | | | | | | | | | total |
| 360 | 9.0-10.0 | <0.6 | 0.4-0.6 | <2.0 | <0.35 | <0.5 | <0.5 | | | | | | <0.25 in |
| | | | | | | | | | | | | | total |
| Version | 8.0-12.0 | 0.6-1.5 | 0.3-0.4 | <0.5 | 0.3-0.6 | <1.5 | <0.5 | 0.03-0.1 | 0.1-0.5 | 0.1-0.5 | 0.1-0.5 | <5 | <0.25 in |
| 1 | | | | | | | | | | | | ppm | total |
| Version | 10.0-12.0 | 0.75-1.5 | 0.35-0.4 | <0.4 | 0.4-0.5 | <0.5 | <0.2 | .03 | 0.15-0.2 | 0.15-0.2 | 0.15-0.2 | <3 | <0.25 in |
| 2 | | | | | | | | | | | | ppm | total |

Reduced Cu Content in the New Aluminum Alloys in Comparison with Traditional 380 & its Variants.

Though copper is generally known to increase strength and hardness in aluminum alloys, on the downside, copper generally reduces the corrosion resistance of aluminum; and, in certain alloys and tempers, copper increases stress corrosion susceptibility. Copper also increases the alloy freezing range and decreases feeding capability, leading to a high potential for shrinkage porosity. Furthermore, copper is expensive and heavy.

Artificial aging (T5) is used to produce precipitation hardening by heating the die castings to an intermediate temperature (e.g., 160-240 degrees C.), and then holding the castings for a period of time to achieve hardening or strengthening through precipitation. Considering that precipitation hardening is a kinetic process, the contents (supersaturation) of the retained solute elements in the as-cast aluminum solid solution play an important role in the aging responses of the HPDC castings. Therefore, the availability and actual amount of hardening solutes in the aluminum soft matrix solution after casting has an effect on subsequent aging. In the production of HPDC parts, the temperature upon removal from the dies and the subsequent quench speed are the significant factors influencing the degree of supersaturation.

In addition, in current HPDC practice, the parts are often slowly cooled to a low temperature, such as below 200 degrees C., prior to die ejection and quench. This significantly diminishes the subsequent aging potential. This is because the solubility of the hardening solute, such as copper and/or magnesium, decreases significantly with decreasing temperature at which the part is quenched. As a result, the remaining copper or magnesium solute in the aluminum matrix for subsequent age hardening is very limited. Thus, although commercially available alloys may contain 3˜4% copper in nominal composition, most of it is combined with other elements forming intermetallic phases. Without solution treatment, the as-cast copper-containing intermetallic phases will not contribute any age hardening to the material. Therefore, the high copper addition in the current HPDC alloys used in production is not effective in terms of both property improvement and quality assurance.

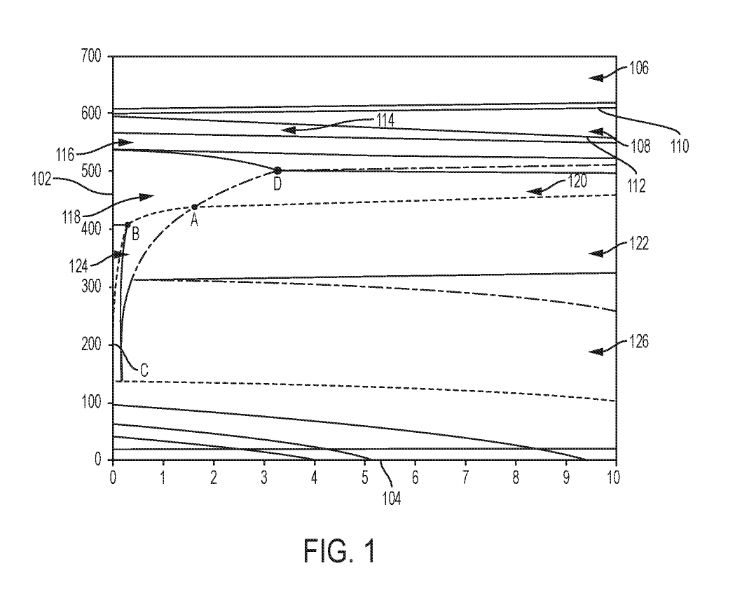

Thus, although typical HPDC aluminum alloys, such as A380, 380 or 383, contain 3˜4% Cu in nominal composition, the actual Cu solute remaining in the as-cast aluminum matrix for the subsequent aging is not that high. FIG. 1 illustrates a calculated phase diagram of an A380 HPDC alloy (8.5 wt % Si, 1.3 wt % Fe, 0.2 wt % Mg, 0.5 wt % Mn, 0.5% wt % Ni, and 3% Zn), showing phase transformations during cooling as a function of Cu content. Temperature in degrees Celsius is shown on the Y-axis, indicated as element 102, shown from a high of 700 degrees C. down to a low of 0 degrees C.; and wt % copper is shown on the X-axis, indicated as element 104, from 0 to 10 wt % Cu. At the highest temperatures, the alloy A380 is liquid at any percentage Cu between 0 and 10 wt %, as indicated in section 106. Each plotted line on the graph marks the boundary of a phase transformation as the alloy is cooled. For example, in section 108 between lines 110 and 112 (which corresponds to the temperatures and weight percentages shown on the Y- and X-axes corresponding to section 108 shown in FIG. 3), the A380 alloy contains a liquid, Al₅FeSi, and Al₁₅FeMn₃Si₂. In section 114, liquid, Al, Al₅FeSi, and Al₁₅FeMn₃Si₂ are present. In section 116, liquid, Al, Si, Al₅FeSi, and Al₁₅(FeMn)₃Si₂ are present. In section 118, Al, Si, Al₃Ni, Al₁₅(FeMn)₃Si₂, and Al₅FeSi are present. In section 120, Al, Si, Al₃Ni, Al₅FeSi, Al₁₅(FeMn)₃Si₂, and Al₂Cu are present. In section 122, Al, Si, Al₃Ni, Al₅Cu₂Mg₈Si₆, Al₁₅(FeMn)₃Si₂, Al₅FeSi, and Al₂Cu are present. In section 124, Al, Si, Al₃Ni, Al₅Cu₂Mg₈Si₆, Al₅FeSi, and Al₁₅(FeMn)₃Si₂ are present. In section 126, Al, Si, Al₃Ni, Al₅Cu₂Mg₈Si₆, Al₅FeSi, Al₁₅(FeMn)₃Si₂, and τ(Al, Cu, Zn) are present. Point A, corresponding to 1.56 wt % Cu at 437 degrees C., indicates that the maximum solubility of Cu in the aluminum matrix is about 1.56 wt % Cu. Point B is located at a point which is 0.27 wt % Cu. Point C is at 200 degrees C. and 0.006 wt % Cu. Point D corresponds to 3.3 wt % Cu and 500 degrees C.

As shown in FIG. 1, the maximum solubility of Cu in aluminum matrix is about 1.56% when the casting is quickly cooled at about 437° C., which is shown at point A. A majority of the Cu is tied up during solidification with Fe and other elements forming intermetallic phases which have no aging responses if the components/parts do not undergo high temperature solution treatment. In this case, the as-cast Cu-containing intermetallic phases is similar to other second phase particles like Si.

Therefore, it is proposed with the present alloy to reduce Cu content no more than 1.5 wt % in the new alloy for better castability in terms of shrinkage porosity reduction. Using less copper will also improve corrosion resistance, save on cost, and allow the alloy to weigh less (have less density).

Increased Mg in the New Aluminum Alloys in Comparison with Traditional 380 & its Variants.

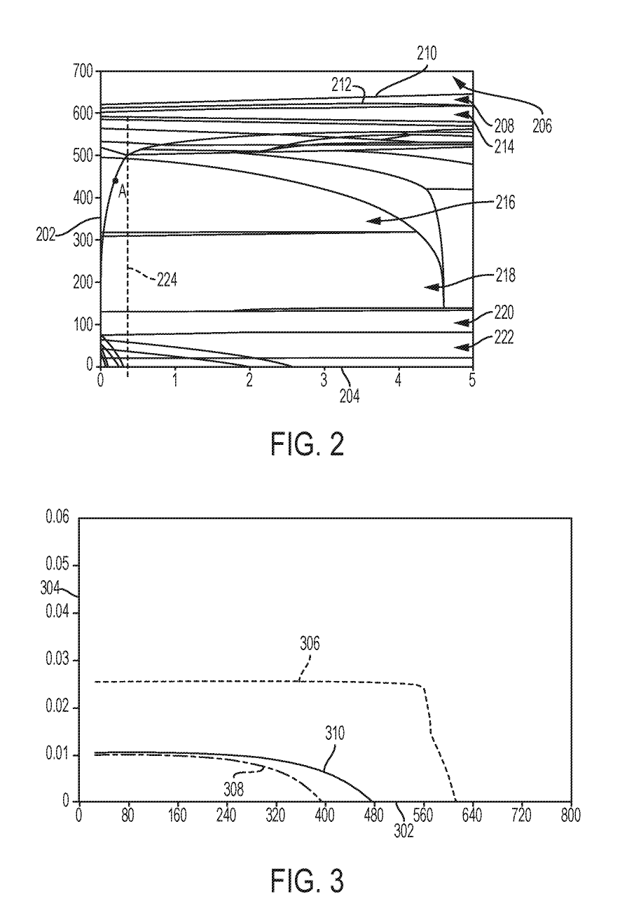

To further improve the aging response of cast aluminum alloy, magnesium content in the new alloy should be kept no less than 0.2 wt %, and the preferred level is above 0.3 wt %. For the castings being subject to only a T5 aging process, the maximum Mg content should be kept below 0.4 wt %, with a preferable level of 0.35 wt %, so that a majority of the Mg addition will stay in Al solid solution after rapid solidification as in high pressure die casting, as shown in FIG. 2.

For example, referring to FIG. 2, FIG. 2 illustrates a calculated phase diagram of an A380 HPDC alloy (8.5 wt % Si, 1.3 wt % Fe, 3 wt % Cu, 0.5 wt % Mn, 0.5% wt % Ni, and 3% Zn), showing phase transformations during cooling as a function of Mg content. Temperature in degrees Celsius is shown on the Y-axis, indicated as element 202, shown from a high of 700 degrees C. down to a low of 0 degrees C.; and wt % magnesium is shown on the X-axis, indicated as element 204, from 0 to 5 wt % Mg. At the highest temperatures, the alloy A380 is liquid at any percentage Mg between 0 and 5 wt %, as indicated in section 206. Each plotted line on the graph marks the boundary of a phase transformation as the alloy is cooled. For example, in section 208 between lines 210 and 212, the A380 alloy contains a liquid and Al₁₅FeMn₃Si₂. In section 214, liquid, Al₅FeSi, and Al₁₅(FeMn)₃Si₂ are present. In section 216, Al, Si, Al₅FeSi, Al₃Ni, Al₁₅(FeMn)₃Si₂, Al₂Cu, and Al₅Cu₂Mg₈Si₆ are present. In section 218, Al, Si, Al₅Cu₂Mg₈Si₆, Al₅FeSi, Al₃Ni, Al₁₅(FeMn)₃Si₂, and τ(Al, Cu, Zn) are present. In section 220, Al, Si, Al₅FeSi, Al₁₅(FeMn)₃Si₂, Al₃Ni, Mg₂Si, and τ(Al, Cu, Zn) are present. In section 222, Al, Si, Al₅FeSi, Al₁₅(FeMn)₃Si₂, Al₃Ni, Mg₂Si, SIGMA, and τ(Al, Cu, Zn) are present. Dashed line 224 corresponds to 0.34 wt % Mg. Point A corresponds to 0.19 wt % Mg at 437 degrees C., which is the temperature point of maximum solubility of Cu in the aluminum matrix (which corresponds to 1.56 wt % Cu, as shown in FIG. 1).

It was discovered that there was essentially no further improvement in strength when Mg was about 0.4 wt %.

Referring to FIG. 3, FIG. 3 illustrates that there will be no Mg₂Si forming in the as-cast microstructure of the new alloy. For example, with a new HPDC block aluminum alloy containing 11 wt % Si, 1 wt % Cu, 0.4 wt % Fe, 0.5 wt % Mn, and 0.35 wt % Mg, the phase fraction (f) is illustrated as a function of temperature in degrees Celsius. Temperature in degrees Celsius is shown on the X-axis, indicated as element 302, shown from a low of 0 degrees C. to a high of 800 degrees C.; and phase fraction (f) is shown on the Y-axis, indicated as element 304, from 0 to 0.06. Line 306 illustrates the phase fraction of Al₁₅(FeMn)₃Si₂; line 308 illustrates the phase fraction of Al₂Cu; and line 310 illustrates the phase fraction of Al₅Cu₂Mg₈Si₆. However, note that no Mg₂Si is illustrated in the phase fraction diagram of FIG. 3, as Mg₂Si is not present in the new alloy.

Reduced Zn in the New Aluminum Alloys in Comparison with Traditional 380 & its Variants

Zn can significantly increase alloy shrinkage tendency.

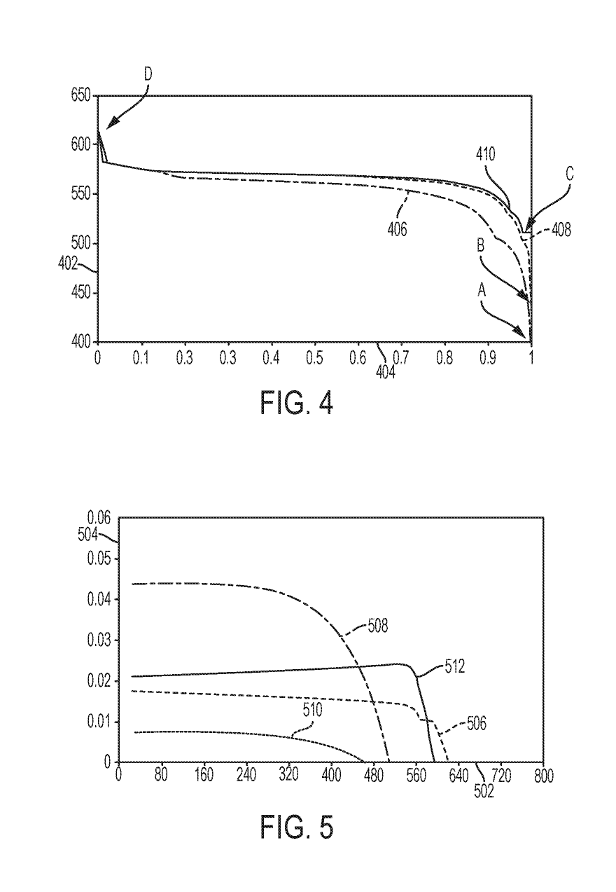

FIG. 4 illustrates the solid fraction (fs) as a function of temperature in degrees Celsius, for two versions of the new alloy having different amounts (0 wt % and 0.5 wt %) of zinc and for a traditional 380 alloy having 2 wt % Zn. Temperature in degrees Celsius is shown on the Y-axis, indicated as element 402, shown from a low of 400 degrees C. to a high of 650 degrees C.; and solid fraction (fs) is shown on the X-axis, indicated as element 404, from 0 to 1. FIG. 4 shows the calculated solid fractions during solidification showing the effect of zinc on the alloy solidus (solidus is the temperature at which the alloy is fully solidified).

Line 406 illustrates the solid fraction curve (as a function of temperature) of a traditional 380 alloy containing 2 wt % Zn; line 408 illustrates the solid fraction curve of a version of the new alloy containing 0.5 wt % Zn; and line 410 illustrates the solid fraction curve of a version of the new alloy containing 0 wt % Zn. The solidus for the traditional 380 alloy is indicated at A; the solidus for the new alloy containing 0.5 wt % zinc is indicated at B; and the solidus for the new alloy containing 0 wt % zinc is indicated at C. The liquidus is for all three is indicated at D.

As shown in FIG. 4, high Zn (2%) in the traditional 380 alloy dramatically increases the alloy freezing range (Liquidus-Solidus) and thus shrinkage porosity tendency. However, as shown, keeping the zinc level under 0.5 wt % increases the solidus and decreases the freezing range, which has the effect of reducing shrinkage porosity. Thus, to reduce alloy shrinkage porosity and increase alloy solidus, zinc in the new alloy should is kept at no more than 0.5 wt %, and the preferred level is less than 0.2 wt %.

Optimized Other Alloying Elements in the New Alloy

Referring now to FIG. 5, FIG. 5 illustrates the phase fraction (f) of A380 (containing Al, 8.5 wt % Si, 3.5 wt % Cu, 1 wt % Fe, 0.25 wt % Mn, and 0.25 wt % Mg) as a function of temperature in degrees Celsius. Temperature in degrees Celsius is shown on the X-axis, indicated as element 502, shown from a low of 0 degrees C. to a high of 800 degrees C.; and phase fraction (f) is shown on the Y-axis, indicated as element 504, from 0 to 0.06. Line 506 illustrates the phase fraction of Al₁₅(FeMn)₃Si₂; line 508 illustrates the phase fraction of Al₂Cu; line 510 illustrates the phase fraction of Al₅Cu₂Mg₈Si₆; and line 512 illustrates the phase fraction of Al₅FeSi.

In traditional HPDC 380 alloy, high Fe content (˜1%) is used to reduce die soldering. High Fe content significantly increases alloy shrinkage porosity and reduces material ductility due to the formation of beta-Fe phase (Al₅FeSi, ˜2.5 vol %), as shown in FIG. 5. In the new alloy, Fe is optimized at 0.4 wt % and Mn at 0.5 wt % to eliminate formation of beta-Fe phase, as shown in FIG. 3 (no beta-Fe phase is present).

To maintain the alloy die soldering resistance, the alloy equivalent sludge factor can be used to control the Fe and Mn content. The sludge factor is calculated by:

Sludge factor=(1×wt % Fe)+(2×wt % Mn)+(3×wt % Cr) (1)

It is preferred that the sludge factor for the new alloy be controlled below 1.4 to avoid sludge formation in melting furnace when melt temperature in holding furnace is at 620° C. (1150° F.). When the melt temperature in the holding furnace is at 660° C. (1230° F.), the sludge factor should be less than 2.0.

In the present case, applying the sludge factor equation, if Fe is provided at 0.4 wt % and Mn is provided at 0.5 wt %, and essentially 0 chromium is provided, the sludge factor is 1.4: (0.4(+0.5*2=1.4).

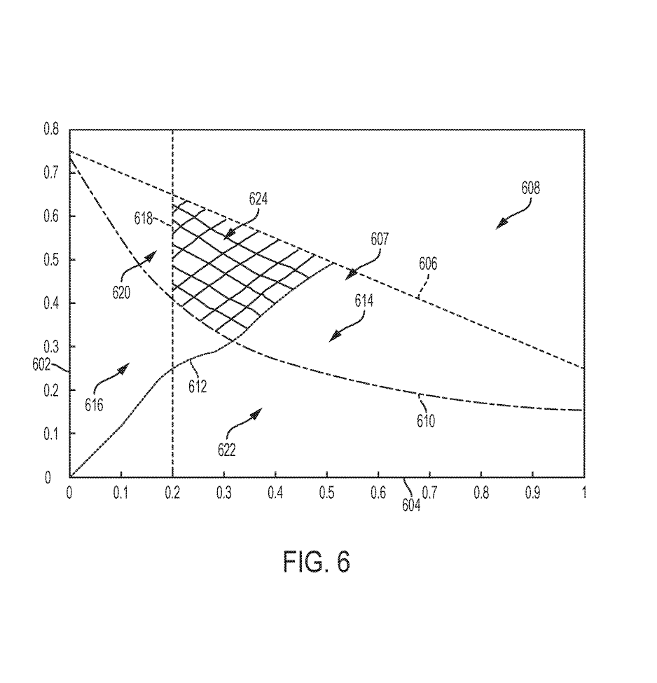

Referring to FIG. 6, an Fe—Mn interaction map is illustrated to show an optimized operation window for better castability and low alloy cost. FIG. 6 illustrates wt % Mn as a function of wt % Fe. Weight percent (wt %) Mn is shown on the Y-axis, indicated as element 602, shown from a low of 0 to a high of 0.8 wt % Mn; and weight percent (wt %) Fe is shown on the X-axis, indicated as element 604, from a low of 0 to a high of 1. A sludge factor line is illustrated at 606, which is plotted based on the sludge factor equation (1) above, with the sludge factor equaling 1.5, and with chromium being 0. Mn—Fe interaction points above the line 606 have a sludge factor greater than 1.5. Amounts of Mn and Fe corresponding to a sludge factor above 1.5 are plotted in an area 608 above the sludge factor threshold line 606, and amounts of Mn and Fe having a sludge factor of less than 1.5 are located in an area 607 below the sludge factor threshold line 606.

A lower boundary line 610 is the soldering prevention line. The soldering prevention line 610 is a line above which soldering has been determined not to be substantially possible, which was determined by experimentation. The soldering prevention line 610 is a line below which die soldering of the aluminum alloy occurs. In other words, with a threshold level of Mn and Fe, die soldering is greatly reduced or eliminated. Below the soldering prevention line 610, the aluminum alloy sticks to a steel die because soldering occurs between the aluminum alloy and the steel die. It is preferable to substantially eliminate die soldering by providing amounts of Mn and Fe above the soldering prevention line 610.

A right boundary line is indicated at 612. Line 612 is the β-Fe (Al₅FeSi) Phase line. If the alloy contains amounts of Mn and Fe corresponding to points greater than the β-Fe (Al₅FeSi) Phase line 612, in area 614, the alloy will include β-Fe (Al₅FeSi) Phase; and if the alloy contains amounts of Mn and Fe corresponding to points to the left of (lesser than) the β-Fe (Al₅FeSi) Phase line 612, in area 616, the alloy will be free of, or substantially free of, β-Fe (Al₅FeSi) Phase.

A left boundary line is indicated at 618. Line 618 is the primary-alloy/secondary-alloy line. Line 618 could also be called the cost-effective line, and line 618 corresponds with 0.2 wt % Fe. Expensive processes are required to remove Fe from natural aluminum to amounts lower than 0.2 wt % Fe. At points to left of line 618 (having Fe lower than 0.2 wt %), in area 620, the alloy is a primary aluminum alloy, which is considered a premium alloy that is expensive to produce. At points to the right of line 618 (having Fe higher than 0.2 wt %), in area 622, the alloy is a secondary aluminum alloy, which is cost-effective to produce or obtain.

In some examples of the present alloy, the amounts of Mn and Fe included correspond to the optimized section 624 on the graph of FIG. 6. In the optimized section 624, the sludge factor is below 1.5 (or 1.4 in some examples), and thus, Mn and Fe are provided in amounts corresponding to the area 607 below the sludge factor threshold line 606. In addition, the Fe is provided in an amount greater than the primary-alloy/secondary-alloy line 618 in the area 622; thus Fe is provided in an amount that is about 0.2 wt % or greater. Further, the Mn and Fe are provided in an amount above the soldering prevention line 610 to reduce or eliminate die soldering, and the Mn and Fe are provided in amount left of the β-Fe (A15FeSi) Phase line, so that the alloy contains essentially zero β-Fe (Al₅FeSi) Phase.

In the new alloy, mean Si content is increased from 8.5 wt % in traditional A380 to 11 wt %. Increasing Si near the eutectic composition (˜12%) can help reduce freezing range and thus increase castability and quality of the casting. To control the Si particle morphology, a morphology improver such as Sr, Na, or Sb (up to 0.1 wt %) may be used. In some forms, amounts between about 0.03 wt % and about 0.1 wt % of the morphology improver may be included. In the new alloy, it is also proposed to control P content (<3 ppm) to produce fine Si particles even without Sr, Na, or Sb modification. In variations, P content is controlled at or below about 5 ppm.

To further improve alloy performance at elevated temperatures, the alloy may contain 0.5 wt % max titanium (Ti) (or 0 to about 0.5 wt % Ti), 0.5 wt % max zirconium (Zr) (or 0 to about 0.5 wt % Zr), 0.5 wt % max vanadium (V) (or 0 to about 0.5 wt % V), and 0.25 wt % max (or 0 to about 0.25 wt %) other total trace elements. In some versions, each of the Ti, Zr, and V may be provided in amounts of about 0.1 to about 0.5 wt %; and in some versions, each of the Ti, Zr, and V may be provided in amounts of about 0.15 to about 0.2 wt %.

Reduced Density of the New Alloy

Based on thermodynamic calculation, the new alloy is lighter than traditional A380 alloys. In some forms, the new alloy is about 3% lighter. Table 2 compares the density of the new alloy with that of A380 alloys currently used in production.

TABLE 2
Comparison of alloy compositions and density.

| | | | | | | | Density | Density |
|---|---|---|---|---|---|---|---|---|
| | Si | Fe | Cu | Mn | Mg | Zn | (g/cm³) | Comp. |
| 383 | 10.58 | 1.11 | 3.09 | .025 | .24 | 1.65 | 2.78 | 1.03 |
| A380 | 9.6 | 1.1 | 3.45 | 0.22 | .032 | 1.5 | 2.79 | 1.03 |
| Example | 10.5 | 0.4 | 1.5 | 0.5 | 0.35 | 0.2 | 2.7 | 1 |
| 1 of the | | | | | | | | |
| new alloy | | | | | | | | |

Demonstration

In one example (referred to as Example 2), shown Table 3, the new alloy contains essentially no copper. In this example, the new alloy does contain about 8.5 wt % Si, about 0.4 wt % Fe, about 0.5 wt % Mn, about 0.4 wt % Mg, about 0.5 wt % Zn, about 0.3 wt % Zr, about 0.3 wt % Ti, about 0.3 wt % V, about 0.04 wt % Sr, max of about 0.01 wt % (or 0 to about 0.01 wt %) of all other trace elements, and the balance of aluminum. Table 4 compares the mechanical properties and corrosion resistance of the new alloy with commercial alloys 380 and 360. It is seen that the new alloy has not only higher tensile properties but also better corrosion resistance.

TABLE 3
One example (Example 2) of the chemical
compositions of the new alloy.

| | Element level (wt %) | | | | | | | | | |
|---|---|---|---|---|---|---|---|---|---|---|
| Element | Si | Mn | Zn | Zr | Ti | V | Mg | Fe | Sr | Al |
| Example 2 | 8.5 | 0.5 | 0.5 | 0.3 | 0.3 | 0.3 | 0.4 | 0.4 | 0.04 | Bal- |
| | | | | | | | | | | ance |

TABLE 4
Comparison of mechanical properties and corrosion resistance
of the new alloy with commercial alloys 380 and 360.

| | | | | | | | | Soaked at 200 deg. C. | | |
|---|---|---|---|---|---|---|---|---|---|---|
| | | | | | | | | for 200 hours and | | |
| | As-Cast | | | | T5 | | | tested at 200 deg. C. | | |
| | YS | UTS | El | Corrosion | YS | UTS | El | YS | UTS | El |
| Alloy | (MPa) | (MPa) | (%) | (mm/yr) | (MPa) | (MPa) | (%) | (MPa) | (MPa) | (%) |
| Example 2 | 160 | 281 | 4.21 | 0.07 | 235 | 332 | 3 | 160 | 200 | 6.5 |
| A360 | 150 | 235 | 1.7 | 0.21 | 159 | 250 | 1.1 | 129 | 146 | 2.3 |
| A380 | 145 | 240 | 2.2 | 0.35 | 146 | 270 | 1.6 | 123 | 148 | 3.1 |

In another example, Table 5, the new alloy (referred to as Example 3) contains essentially no copper as well, but Example 3 does contain about 12 wt % Si, about 0.4 wt % Fe, about 0.5 wt % Mn, about 0.35 wt % Mg, about 0.2 wt % Zn, about 0.25 wt % Zr, about 0.25 wt % Ti, about 0.04 wt % Sr, a maximum of about 0.01 wt % of all other trace elements, and the balance of aluminum. Table 6 compares the mechanical properties and corrosion resistance of the new alloy (Example 2) with commercial alloys 380 and 360. It is again seen that the new alloy has better performance in both tensile properties and corrosion resistance.

TABLE 5
Another example (Example 3) of the chemical
compositions of the new alloy.

| | Element level (wt %) | | | | | | | | | |
|---|---|---|---|---|---|---|---|---|---|---|
| Element | Si | Mn | Zn | Zr | Ti | V | Mg | Fe | Sr | Al |
| Example 3 | 12 | 0.5 | 0.2 | 0.25 | 0.25 | 0.25 | 0.35 | 0.4 | 0.04 | Bal- |
| | | | | | | | | | | ance |

TABLE 6
Comparison of mechanical properties and corrosion resistance
of the new alloy with commercial alloys 380 and 360

| | | | | | | | | Soaked at 200 deg. C. | | |
|---|---|---|---|---|---|---|---|---|---|---|
| | | | | | | | | for 200 hours and | | |
| | As-Cast | | | | T5 | | | tested at 200 deg. C. | | |
| | YS | UTS | El | Corrosion | YS | UTS | El | YS | UTS | El |
| Alloy | (MPa) | (MPa) | (%) | (mm/yr) | (MPa) | (MPa) | (%) | (MPa) | (MPa) | (%) |
| Example 3 | 185 | 310 | 2.8 | 0.09 | 251 | 340 | 1.9 | 152 | 216 | 4.3 |
| A360 | 150 | 235 | 1.7 | 0.21 | 159 | 250 | 1.1 | 129 | 146 | 2.3 |
| A380 | 145 | 240 | 2.2 | 0.35 | 146 | 270 | 1.6 | 123 | 148 | 3.1 |

The alloys described herein may be used to manufacture a HPDC cast article, such as an engine block. Therefore, it is within the contemplation of the inventors herein that the disclosure extend to cast articles, including engine blocks, containing the improved alloy (including examples, versions, and variations thereof).

Furthermore, while the above examples are described individually, it will be understood by one of skill in the art having the benefit of this disclosure that amounts of elements described herein may be mixed and matched from the various examples within the scope of the appended claims.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. An aluminum alloy suitable for high pressure die casting, the aluminum alloy comprising:
about 8 to about 12 weight percent silicon;
about 0.5 to about 1.5 weight percent copper;
about 0.2 to about 0.4 weight percent magnesium;
0 to about 0.5 weight percent iron;
about 0.3 to about 0.6 weight percent manganese;
0 to about 1.5 weight percent nickel; and
0 to about 0.5 weight percent zinc.

2. The aluminum alloy of claim 1, further comprising about 80 to about 91 weight percent aluminum.

3. The aluminum alloy of claim 2, further comprising about 0.1 to about 0.5 weight percent titanium, about 0.1 to about 0.5 weight percent zirconium, and about 0.1 to about 0.5 weight percent vanadium.

4. The aluminum alloy of claim 3, wherein the aluminum alloy contains:
about 10 to about 12 weight percent silicon;
about 0.75 to about 1.5 weight percent copper;
about 0.35 to about 0.4 weight percent magnesium;
0 to about 0.4 weight percent iron;
about 0.4 to about 0.5 weight percent manganese;
0 to about 0.5 weight percent nickel; and
0 to about 0.2 weight percent zinc.

5. The aluminum alloy of claim 4, further comprising about 0.15 to about 0.2 weight percent titanium, 0.15 to about 0.2 weight percent zirconium, and 0.15 to about 0.2 weight percent vanadium.

6. The aluminum alloy of claim 5, further comprising 0 to about 0.25 weight percent of trace elements not selected the group consisting of: titanium, vanadium, and zirconium.

7. The aluminum alloy of claim 3, further comprising about 0.03 to about 0.1 weight percent of a morphology improver selected from the group consisting of: strontium, sodium, antimony, and combinations thereof.

8. The aluminum alloy of claim 7, further comprising about 0 to about 5 ppm phosphorus.

9. The aluminum alloy of claim 8, wherein the iron and manganese content are provided each in an amount so that a sludge factor is less than or equal to 1.4, wherein the sludge factor is calculated by the following equation:
Sludge factor=(1×wt % iron)+(2×wt % manganese)+(3×wt % chromium),
and wherein the aluminum alloy contains essentially 0 chromium.

10. The aluminum alloy of claim 9, wherein the aluminum alloy contains essentially 0 Beta Iron Phase (β-Fe Phase).

11. The aluminum alloy of claim 10, wherein the aluminum alloy comprises about 0.2 weight percent to about 0.5 weight percent iron.

12. The aluminum alloy of claim 11, wherein the manganese and the iron are each provided in an amount above a soldering prevention line, the soldering prevention line being defined as a line below which die soldering of the aluminum alloy occurs.

13. The aluminum alloy of claim 9, wherein the aluminum alloy is lighter than an A380 aluminum alloy.

14. The aluminum alloy of claim 13, wherein the aluminum alloy as-cast and prior to any age-hardening has a yield strength greater than or equal to 160 MPa, an ultimate tensile strength greater than or equal to 281 MPa, and a strain of at least 2.8%; and wherein the aluminum alloy, after undergoing a T5 age-hardening treatment, has a yield strength greater than or equal to 235 MPa, an ultimate tensile strength greater than or equal to 332 MPa, and a strain of at least 1.9%.

15. The aluminum alloy of claim 1, consisting essentially of:
about 10.5 weight percent silicon;
about 0.4 weight percent iron;
about 1.5 weight percent copper;
about 0.5 weight percent manganese;
about 0.35 weight percent magnesium;
about 0.4 weight percent zinc; and
the balance aluminum.

16. The aluminum alloy of claim 1, consisting essentially of:
about 8.5 weight percent silicon;
about 0.5 weight percent manganese;
about 0.5 weight percent zinc;
about 0.3 weight percent zirconium;
about 0.3 weight percent titanium;
about 0.3 weight percent vanadium;
about 0.4 weight percent magnesium;
about 0.4 weight percent iron;
about 0.04 weight percent of a morphology improver selected from the group consisting of strontium, sodium, antimony, and combinations thereof;
0 to about 0.01 weight percent trace elements; and
the balance aluminum.

17. The aluminum alloy of claim 1, consisting essentially of:
about 12 weight percent silicon;
about 0.5 weight percent manganese;
about 0.2 weight percent zinc;
about 0.25 weight percent zirconium;
about 0.25 weight percent titanium;
about 0.25 weight percent vanadium;
about 0.35 weight percent magnesium;
about 0.4 weight percent iron;
about 0.04 weight percent of a morphology improver selected from the group consisting of strontium, sodium, antimony, and combinations thereof;
0 to about 0.01 weight percent trace elements; and
the balance aluminum.

18. A high pressure die cast article, cast from an aluminum alloy according to claim 3.

19. A high pressure die cast article, cast from an aluminum alloy according to claim 4.

20. A high pressure die cast engine block, cast from an aluminum alloy according to claim 3.
